(19) United States
(12) Patent Application Publication
(10) Pub. No.: US 2022/0130184 A1
(43) Pub. Date: Apr. 28, 2022

(54) FLIGHT DATA RECORDER FOR UNMANNED AIRCRAFT SYSTEMS

(71) Applicant: AlarisPro, Inc., Baltimore, MD (US)

(72) Inventor: Anthony J. PUCCIARELLA, Lusby, MD (US)

(73) Assignee: AlarisPro, Inc., Blatimore, MD (US)

(21) Appl. No.: 17/390,140

(22) Filed: Jul. 30, 2021

Related U.S. Application Data
(60) Provisional application No. 63/104,243, filed on Oct. 22, 2020.

(51) Int. Cl. G07C 5/08; B64D 45/00; B64C 39/02; G01C 23/00; H04W 4/80

(52) U.S. Cl. CPC G07C 5/085; B64D 45/00; B64C 39/024; H04W 84/042; H04W 4/80; B64C 2201/00; G01C 23/005

(57) ABSTRACT

The invention is that of a flight data recorder with significant reduction in size, weight and power making it suitable for use with most unmanned aircraft systems (UAS). A flight data recorder of the present invention may be mounted to a UAS or stored in a payload bay or compartment therein. It is an object of the invention to enable programming aircraft flights and recording flight data when autopilot fails, dramatically improving data collection and the ability to determine flight limits and detect problems. An FDR according to the present invention comprises onboard hardware and software systems enabling the programmable collection, storage and processing of flight data along with a means of transferring data to other devices for use. It is an object of the invention to enable wireless data transmissions while maintaining the ability to disable wireless transceivers during flight to prevent interference with flight management signals.

### CROSS-REFERENCE TO RELATED APPLICATIONS

This application claims benefit under 35 U.S.C. § 119(e) of U.S. Provisional Application No. 63/104,243 filed on Oct. 22, 2020, the entire contents of all of which are incorporated herein by reference.

### BACKGROUND OF TRE INVENTION

The invention of the present disclosure relates to the field of Flight Data Recorders (FDRs), and in particular external independent flight data recorders suitable for use with unmanned aircraft systems (UAS) such as drones and unmanned helicopters. Currently, while UAS autopilots record much of the same data to be captured by an FDR as described herein, no independent source to collect this data is available. Additionally, in the event of autopilot issues, there arises a need in the art for a UAS FDR to provide an independent source of flight data for comparison to the data recorded by the autopilot.

Commercial off-the-shelf (COTS) tracking boxes used, for example, for tracking shipments, provide some of the same data as an FDR as described herein but do not include embedded software that determines flight status based on parameters of interest to the user, nor do these COTS trackers provide an independent source for documenting individual flights for use in fleet management and aviation forensics. As such, there is a need in the art for an FDR that is an independent source for providing these desirable features, suitable for use with UAS, in particular without integration into the UAS itself and certification that the FDR meets regulatory requirements of aviation agencies such as the U.S. Federal Aviation Administration (FAA), which is a costly and involved process.

To wit, traditional flight recorders—sometimes referred to as “black boxes”—are heavy, expensive, and require complex integrations with an aircraft's existing flight management system. Integration with certified aircraft systems requires extensive resources and must be certified by an airworthiness authority such as the FAA. Additionally, black boxes are used for only post-incident forensics whereas a UAS FDR as described herein can be used for routine documentation of flight operations as part of a fleet management program, using an independent source. An FDR as described herein is configured as a standalone, independent device, so no integration or certification is required. Therefore, the invention of the present disclosure meets multiple unmet needs in the art.

### SUMMARY OF THE INVENTION

Described herein is an FDR particularly suitable for UAS applications in preferred embodiments. An FDR as described herein is a lightweight, compact, and independent UAS flight recording solution for all sizes of UAS. Once mounted to a UAS (or carried in a payload bay or compartment), a UAS FDR according to the present invention automatically documents important flight data for numerous flights over a period of weeks or months. As flights of interest are completed, an operator can upload each flight log at once and import the recorded data using compatible fleet management software capable of importing textual flight logs.

A UAS FDR according to the present invention provides an independent source for collection and documentation of multiple data points from UAS flight operations. By providing a standalone source of flight data (compared to using onboard autopilot data, for example), a UAS FDR as described herein comprises an independent data source to document important metrics for design improvement and forensic analysis. In the case of a flight incident or crash, UAS FDR data collected according to the methods recited herein can be compared to autopilot data for independent verification or to determine potential autopilot errors, adding another layer of quality control to flight management operations.

An FDR as described herein is capable of collecting and recording multiple data points. In certain embodiments, the data recorded comprises global positioning system (GPS) position, time, barometric pressure, temperature, acceleration in three dimensions, and more. Onboard software is installed to determine when the flight begins and ends by comparing position, acceleration data and computed altitude. Additionally, the onboard software is used to calculate maximums and averages for all parameters as well as speed of the UAS. These and other features of an FDR according to the present invention are described in further detail below.

### BRIEF DESCRIPTION OF THE DRAWINGS

FIG. 1 illustrates a lower perspective view of an exemplary embodiment of an FDR for unmanned aircraft systems according to the present disclosure.

FIG. 2 illustrates a top view of an exemplary embodiment of an FDR for unmanned aircraft systems according to the present disclosure.

FIG. 3 illustrates a logic flow of methods executed by an FDR according to the present invention.

FIG. 4 illustrates a right side view of an embodiment of an FDR of the present disclosure.

FIG. 5 illustrates a bottom view of the embodiment of FIG. 4.

FIG. 6 illustrates a top perspective view of the embodiment of FIG. 4.

FIG. 7 is a flow chart illustrating key method steps enabled according to the present disclosure.

### DETAILED DESCRIPTION OF THE INVENTION

The invention of the present disclosure is best described with reference to the illustrative embodiments represented in the accompanying drawings, which are provided for illustrative purposes and should not be interpreted as limiting the scope of the invention of the present disclosure.

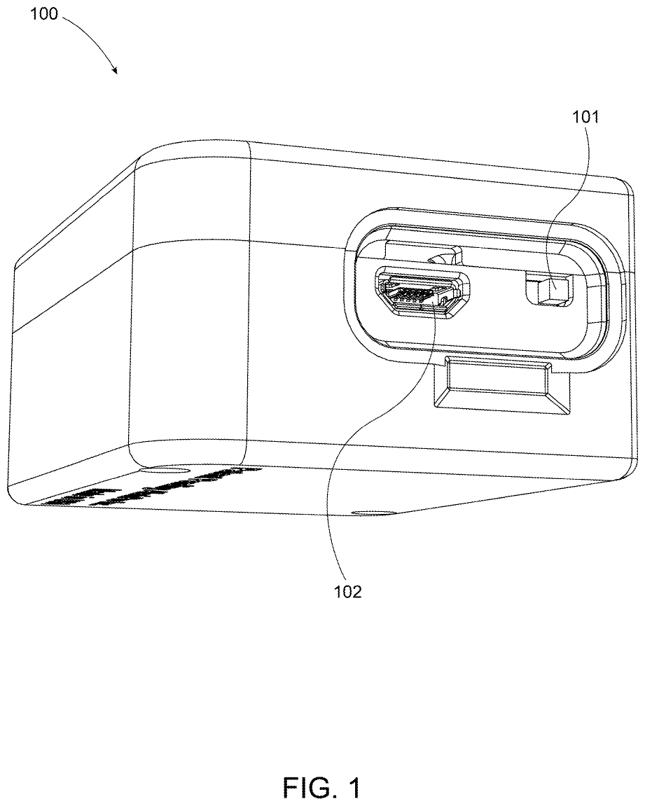

Beginning with FIG. 1, an illustrative embodiment of an FDR 100 of the present invention is shown in lower perspective view. The embodiment shown is useful as a standalone FDR for UAS to be mounted to a UAS or carried in a payload bay or compartment. It is an object of the present invention, for example, to reduce the size, weight and power (SWaP) of an FDR to render it most suitable for UAS applications. One of ordinary skill in the art will be aware that much has been published by government researchers from the FAA and the National Aeronautics and Space Administration (NASA), as well as leading industry engineers, on the importance of reducing SWaP in mission success in the UAS field in civilian and military applications alike.

The embodiment of FIG. 1 is equipped with an easy-to-use on/off switch 101 which may be configured as a button or slide. To the left of the switch is a port for connection of a device for the collection of data for transfer from the FDR to a computer, shown as a Universal Serial Bus (USB) micro connector 102. In alternative embodiments, Bluetooth or another compatible communication standard may be the preferred standard for information transfer. In preferred embodiments, an FDR is equipped with a USB micro connector 102 or equivalent may serve as a data port for collection and subsequent transfer via a data cable, to a computer for storage, analysis and other processing. In a preferred embodiment, an FDR according to the present disclosure is further equipped with a 4G LTE (Long Term Evolution) chip for connection to mobile communications devices according to the 4G LTE standard for transmission and receipt of data or instructions, although one of ordinary skill in the art will recognize that other present and future communications protocols such as Bluetooth or WiFi may be utilized as long as they remain compatible with the invention.

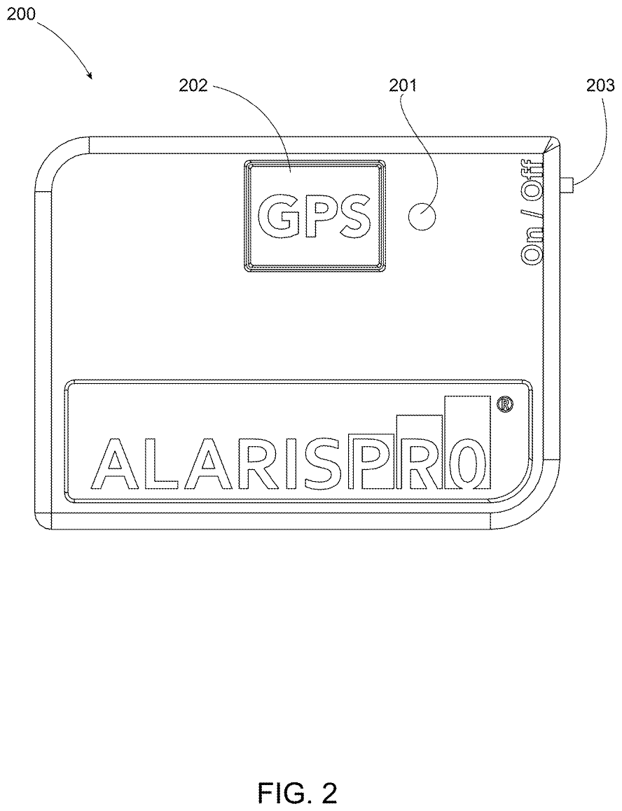

Turning now to FIG. 2, a top view 200 of a UAS FDR according to FIG. 1 is illustrated. The illustrative embodiment of FIG. 2 includes a face with an indicator light 201, which allows users to know when the device has gathered enough GPS information to pinpoint the location of the unit. The indicator light also allows the user to know when the FDR is connected to a suitable USB port as well as its charging status. An indicator light 201 is of sufficient intensity to be visible through the housing. Also, on the face is a molded GPS antenna position indicator 202. The face also includes a charging status indicator such as a light emitting diode (LED) which shows when the FDR is connected to a suitable charging cable and is charging (not shown). Finally, the unit illustrated in FIG. 2 is equipped with a slider switch 203 for powering the system on and off.

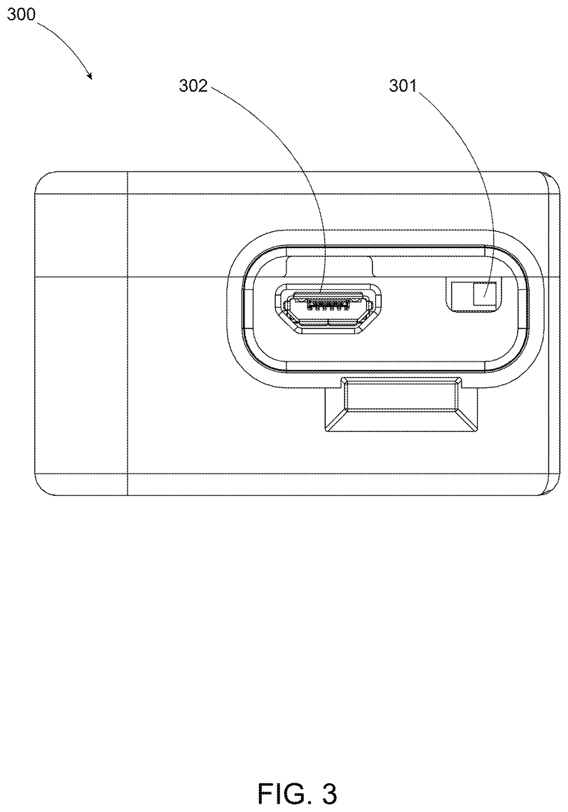

Additional illustrations of the embodiment of FIGS. 1 and 2 are presented in FIGS. 3-5. Accordingly, FIG. 3 illustrates a right side view of the illustrative embodiment 300. The right side of this embodiment is equipped with a power switch 301 configured for left and right sliding to power the FDR on and off. To the left of the power switch is a USB port 302 for the collection of data onto a USB-compatible memory device or direct connection to a USB-equipped computer on which the data collected may be transferred, stored, processed and managed as needed. One of ordinary skill in the art will recognize that the USB port 302 may double as a charging port for the unit.

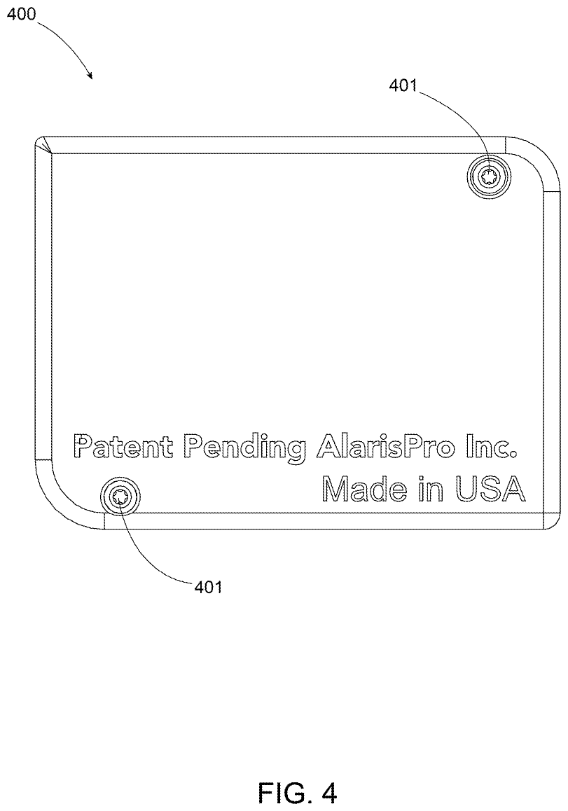

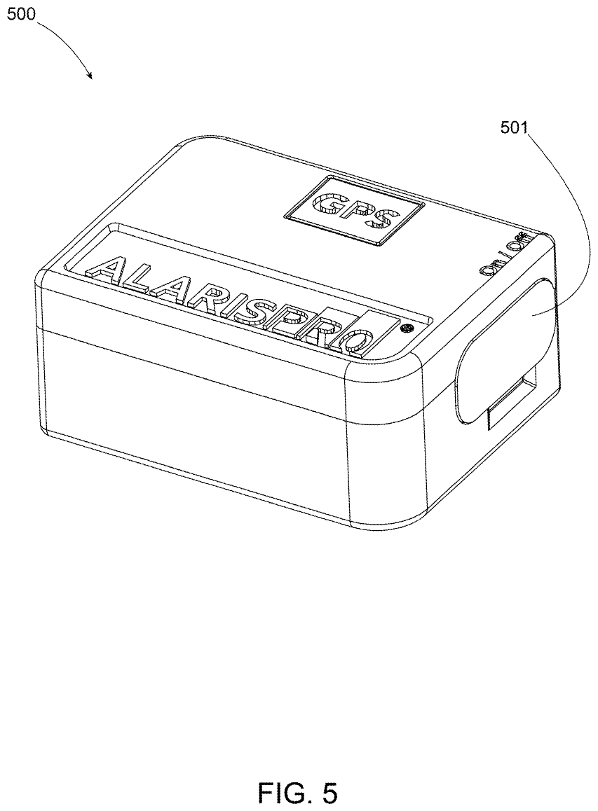

FIG. 4 shows a bottom view of the FDR 400 of this embodiment, illustrating at two corners an attachment and removal capability 401 of the bottom panel for easy replacement of internal components. FIG. 5 provides a top perspective view of the FDR 500, showing the FDR with the right side ingress protection boot 501 in place, although one of ordinary skill in the art will appreciate that ingress may be located at other device locations depending on internal board configurations or other factors.

An FDR according to the present invention may be equipped with hardware not shown in the accompanying drawings, such as a control board, which may be internal to a unit. For example, hardware not pictured may include a device motherboard (printed circuit board or other construction), sensors, and display within a solid housing, preferably a waterproof housing. In certain embodiments, device design may be based on Open Source circuit architecture, such as but not limited to Mbed platform and operating system for Internet of Things (IoT) devices and libraries.

As mentioned above, sensors of a UAS FDR as described herein may include any number of desired sensors within the capacity of a particular unit. Sensors may be selected from the group consisting of GPS sensors (including sensors of position, time, number of satellites, heading and fix quality). Environmental sensors such as sensors of barometric pressure and temperature may also be provided, enabling assessment of the influence of these environmental conditions on UAS component reliability or flight data patterns recorded by an FDR as described herein. In certain embodiments, an FDR as described herein may be equipped with a USB or other suitable charging port for keeping the internal battery charged either during use or when the unit is not in use.

Software incorporated into an FDR as described herein may be stored on a nontransitory computer readable medium and configured to cause a processor to execute instructions to record data referenced to GPS time, GPS latitude and longitude, three-axis accelerometer readings, three-axis gyrometer readings, three-axis magnetometer readings, temperature readings, and pressure readings from included sensors. In exemplary embodiments, onboard software programming instructions cause an associated microprocessor to compute averages for altitude, speed, temperature, and pressure, among other possibilities. Software program instructions may also comprise instructions executed by an associated microprocessor to calculate the start and end of each flight automatically based on user defined GPS location, altitude, acceleration limits, and combinations thereof. Similarly, a software program of an FDR as disclosed herein may comprise instructions which when executed by an associated microprocessor cause the microprocessor to calculate minimum and maximum values for altitude, speed, temperature and pressure.

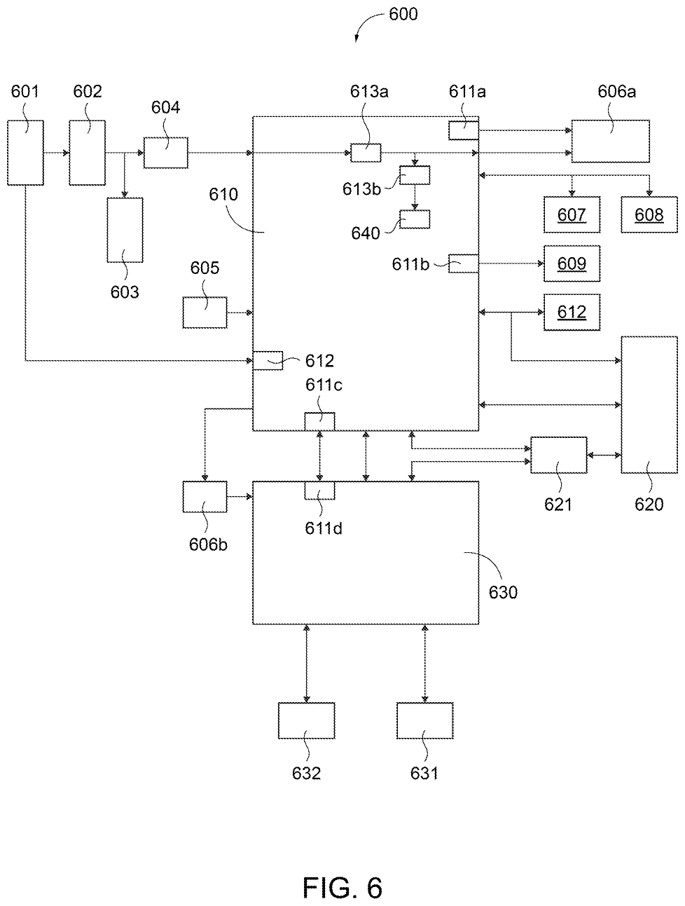

FIG. 6 is a block diagram illustrating an internal component arrangement according to an embodiment of the present disclosure 600. A USB micro input 601 as illustrated in previous figures may be used in connection with a battery charger 602 to charge a battery 603 used to power an FDR as described herein. Battery power is supplied to the system when an on/off switch 604 is set to the on position and voltage is supplied to a central processing unit (CPU) 610. Battery power may be monitored by a battery monitor 605 as voltage flowing through the CPU diminishes.

A CPU 610 as shown in FIG. 6 may comprise a plurality of general purpose input/output ports (GPIOs) 611a-d for receipt of incoming data for processing by the CPU 610 and feedback. In this example, GPIO 611a is connected to a load switch 606a for balancing electrical loads supplied to and from various system components. Information may be exchanged between the CPU and sensors such as a barometer/altimeter 607 and internal measurement unit (IMU) 608 capable of measuring force, orientation and angular rate of a UAS or other associated aircraft. The output of these sensors, in addition to the output of the onboard GPS when compared to programmable limits set by the user or operator allows the FDR to determine dynamically when the FDR is in flight. One of ordinary skill in the art will understand that an IMU for UAS will typically include one or more accelerometers, gyroscopes or magnetometers, or combinations thereof. Voltage regulator 613a is employed to ensure the most efficient use of the available battery energy to components. Voltage regulator 613b is employed to ensure the most efficient use of the available battery energy to the CPU core 640.

Continuing with FIG. 6, GPIO 611b is in communication with an LED 609 as described above and controls its operation. A CPU 610 of the system may also be in communication with memory chip 612 and edge connector 620, which may be useful for programming. A jumper 621 is also shown for redirecting signal paths between the edge connector 620, the CPU 640 and a GPS/modem 630. The GPS/modem 630 is connected to a Global Navigation Satellite System (GNSS) antenna 631 and 4G antenna 632. Load switch 606b is provided to power the GPS/modem 630 up and down. This feature is useful in limiting the amount of power consumed by the GPS/modem 630, which can be significant, as will be appreciated by one of ordinary skill in the art. It is another feature of this configuration to enable the transceiver, such as a Bluetooth transceiver, to power off during flight to avoid interference with signals from a flight controller, which is an object of the invention.

In preferred embodiments, a system as described, including computer board and associated software programs, may be used to generate files such as but not limited to Comma Separated Value (CSV) files for all measurements as well as a flight summary based on flight time, calculated averages, minimums and maximums. The usefulness of these outputs will be readily apparent to one of ordinary skill in the art.

An FDR as described herein is configured to optionally disable onboard Bluetooth communication when entering flight mode and re-enable Bluetooth (or other wireless system) communication when exiting flight mode, reducing the possibility of radio frequency interference with UAS control hardware while the UAS is in flight.

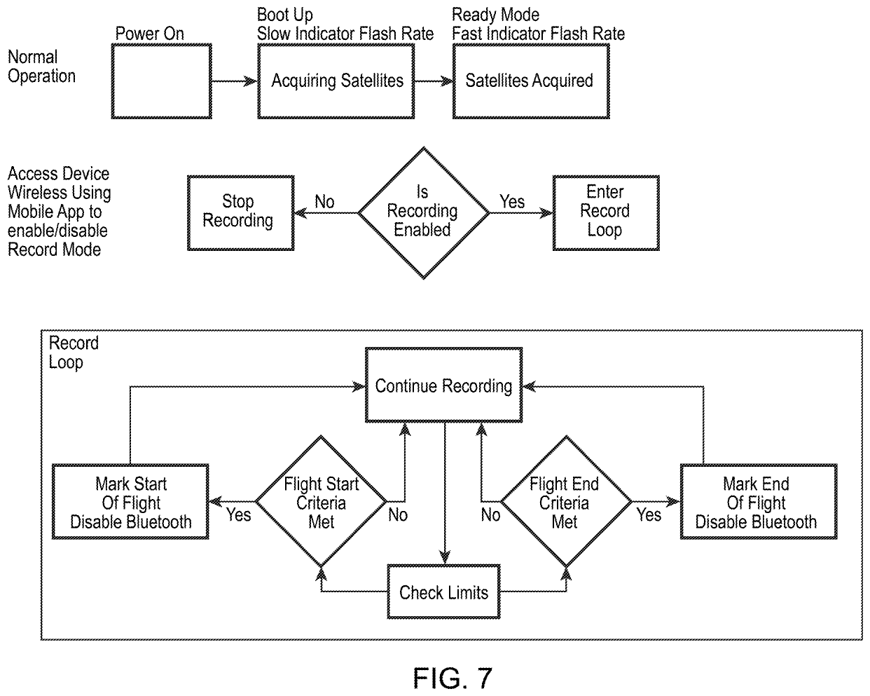

Turning now to FIG. 7, a simple exemplary logic flow of methods enabled by an FDR according to the present invention is illustrated. Normal operation begins by powering the FDR on, which causes the device to boot up and begin acquiring satellites via GPS antenna. An LED flashes slowly during boot-up, then rapidly once the GPS satellites are acquired and the device is ready to record flight data. The FDR may now be accessed via Bluetooth or equivalent to enable record mode and enter the record loop.

The IMU data in combination with sensor data and GPS data are compared to limits set by the user in the associated mobile application and used to determine when flight start criteria are met and an aircraft has taken off. It is one object of the invention that Bluetooth, for example, is disabled at start of flight to prevent interference with flight control signals, which is a shortcoming of current systems. The IMU and other sensors of an FDR of exemplary embodiments of the present invention similarly collect data that can be compared to user-programmable limits by a microprocessor in accordance with associated software instructions to determine whether recording continues, or if flight end criteria are met and the aircraft has landed. Flight time is then recorded. The flight logging process is automatically repeated for as often as take-offs and landings occur with each take-off and landing recorded as a separate flight.

If a user wishes to exit ready mode for any reason, an associated mobile application may be used to disable the record loop and return the unit to standby mode. Standby mode allows a user to change settings and select aircraft using the associated mobile application. Once all of the desired changes are made to any settings, a user can use the associated mobile application to enter record mode and prepare for takeoff.

A control system of an FDR according to the present invention may be further equipped with a memory device such as but not limited to an onboard serial flash memory that may be updated by a fleet manager, for example, to keep current settings that may be changed through the use of a mobile device application in communication with the FDR via Bluetooth or by direct access to the FDR memory via the USB interface. Operators may access fleet information and settings from a web or mobile user interface, but may be denied the ability to modify settings entered by the fleet manager.

As discussed throughout this application, the systems and methods including exemplary hardware and software components as recited herein may be used for the seamless collection of UAS flight data without the need for costly and involved integration and certification of an FDR as described herein. An FDR as described herein is easily portable and capable of easy storage on an aircraft, preferably a UAS. The solution of a UAS FDR according to the present invention offers flexibility and adaptability based on operator and aircraft characteristics and is updatable as needed via associated software programming and computer processing. These and other benefits will be evident to one of ordinary skill in the art. The example embodiments described herein are but a few of many possible examples and should be considered for illustrative purposes and not as limiting on the scope of the invention described herein.

What is claimed is:

1. A flight data recorder within a housing, the flight data recorder comprising:
a battery electrically coupled to a power switch, a charging port, a status indicator and a central processing unit (CPU);
a data transfer means in communication with the CPU;
a global navigation satellite system (GNSS) antenna in communication with the CPU;
an internal measurement unit (IMU) in communication with the CPU;
one or more sensors in communication with the CPU, the one or more sensors selected from the group consisting of a global positioning system (GPS) sensor, a barometer, a thermometer, a gyrometer, an accelerometer, a magnetometer and an altimeter; and
a non-transitory computer readable medium comprising software instructions tangibly stored thereon which cause the CPU to process data received from the IMU and the one or more sensors for storage, display and further processing on a connected computer.

2. The flight data recorder of claim 1, wherein the IMU is configured to measure the force, orientation and angular rate of an aircraft.

3. The flight data recorder of claim 2, further comprising a wireless communications antenna.

4. The flight data recorder of claim 3, wherein the data transfer means comprises a Universal Serial Bus (USB) micro connector and compatible data port.

5. The flight data recorder of claim 3, wherein the data transfer means comprises a Bluetooth transceiver.

6. The flight data recorder of claim 3, wherein the wireless communications antenna is selected from the group consisting of a 4G LTE (Long Term Evolution) antenna and a WiFi antenna.

7. The flight data recorder of claim 3, wherein the status indicator appears differently when the flight data recorder is ready for use than when it is not.

8. The flight data recorder of claim 3, further comprising one or more voltage regulators in communication with one or more load switches, wherein the one or more load switches control the electrical supply to components of the flight data recorder.

9. The flight data recorder of claim 3, further comprising an edge connector in communication with the CPU, wherein the edge connector may program the software instructions.

10. The flight data recorder of claim 3, carried on an unmanned aerial system (UAS), wherein the flight data recorder records data associated with a flight of the UAS.

11. A method of recording flight data of an aircraft, the method comprising:
powering up a flight data recorder according to claim 1 and updating its software instructions to detect horizontal position limits, vertical position limits, acceleration limits or combinations thereof defining a start of a flight of the aircraft and end of flight of the aircraft;
acquiring satellites for navigation of the aircraft and marking the start of a flight of the aircraft;
recording and processing data collected from the IMU and the one or more sensors during the flight of the aircraft; and
marking the end of the flight of the aircraft based on the limits defining the end of the flight of the aircraft.

12. A method of recording flight data of an aircraft, the method comprising:
powering up a flight data recorder according to claim 2 and updating its software instructions to detect horizontal position limits, vertical position limits, acceleration limits or combinations thereof defining a start of a flight of the aircraft and end of flight of the aircraft;
acquiring satellites for navigation of the aircraft and marking the start of a flight of the aircraft;
recording and processing data collected from the IMU and the one or more sensors during the flight of the aircraft; and
marking the end of the flight of the aircraft based on the limits defining the end of the flight of the aircraft.

13. A method of recording flight data of an aircraft, the method comprising:
powering up a flight data recorder according to claim 5 and updating its software instructions to detect horizontal position limits, vertical position limits, acceleration limits or combinations thereof defining a start of a flight of the aircraft and end of flight of the aircraft;
acquiring satellites for navigation of the aircraft and marking the start of a flight of the aircraft;
recording and processing data collected from the IMU and the one or more sensors during the flight of the aircraft; and
marking the end of the flight of the aircraft based on the limits defining the end of the flight of the aircraft;
wherein the Bluetooth transceiver is disabled at the start of the flight.

14. The method of claim 13, wherein the Bluetooth transceiver is disabled as the start of the flight of the aircraft.

15. The method of claim 11, wherein the aircraft is a UAS.

16. The method of claim 12, wherein the aircraft is a UAS.

17. The method of claim 13, wherein the aircraft is a UAS.

18. The method of claim 14, wherein the aircraft is a UAS.

19. A UAS comprising a flight data recorder according to claim 1.

20. A UAS comprising a flight data recorder according to claim 6.
